(19) United States
(12) Patent Application Publication
(10) Pub. No.: US 2016/0294188 A1
(43) Pub. Date: Oct. 6, 2016

(54) ENERGY SUPPLY SYSTEM AND CONDUCTOR LOOP ENCLOSURE

(71) Applicant: Sonnenbatterie GmbH, Wildpoldsried (DE)

(72) Inventor: Torsten STIEFENHOFER, Wildpoldsried (DE)

(73) Assignee: SONNENBATTERIE GMBH, Wildpoldsried (DE)

(21) Appl. No.: 14/673,322

(22) Filed: Mar. 30, 2015

(51) Int. Cl. H02J 3/38; H02J 7/00; H01R 31/06; H02J 9/06

(52) U.S. Cl. CPC H02J 3/382; H02J 9/061; H02J 7/0068; H02J 3/383; H02J 3/386; H01R 31/06

(57) ABSTRACT

An energy supply system for supplying electrical energy to a building, comprising a meter socket adapter, a principal switching device, an electrical backup device, and an appliance disconnector. The meter socket adapter is placed between a service panel socket and a standard utility meter, allowing the principal switching device to disconnect the building from the power grid. The appliance disconnector is then activated to implement an emergency power prioritization.

### FIELD OF THE INVENTION

The invention relates to an energy supply system for supplying electrical energy to a building, whereby the energy comes from an external power grid or from a backup energy source, such as from a photovoltaic device, or from an energy storage device such as a battery, for providing backup energy to appliances inside or about the building.

### BACKGROUND OF THE INVENTION

More and more firms, but also private individuals, are installing alternative energy sources, such as wind turbines or photovoltaic devices, on the premise of their buildings or attached to the buildings themselves, for example on their roofs. Such energy sources may be used to satisfy their own needs for electrical power, and in addition to feed excess electrical power produced by the alternative energy source to the external power grid. When installing an alternative energy source, usually, an energy storage device is also installed at the site to store some of the excess electrical energy provided by the alternative energy source in order to utilize the stored energy at a different time. For example, on very sunny days, a photovoltaic device might produce much more energy than can be consumed by the user. This excess energy may be partly used to charge the energy storage device, such as a battery system, and partly fed into the external power grid. During the night, or on less sunny days, when the electrical power produced by the photovoltaic device is not sufficient for the user's needs, the energy stored in the energy storage device may be utilized to power the building either exclusively or in addition to energy taken from the external grid.

In addition, the alternative energy source and the energy storage device may function as a backup device for supplying electrical energy to appliances in or about the building when there is a failure in the external power grid. For this purpose, an energy supply system has to include means for measuring and monitoring the power level or voltage level of connections coming from the external power grid to the building. Once the power level falls below a certain threshold, the power input has to be switched from the external power grid to the backup device. Such energy supply systems are usually quite complex and installing such a backup device usually involves mounting additional distribution boxes on the building walls next to the main distribution panel.

U.S. Pat. No. 7,648,389 B1 discloses a meter socket adapter, which is placed between a utility meter and its meter socket and provides a power pigtail suitable for connecting a solar panel. U.S. Pat. No. 6,188,145 B1 and its continuation U.S. Pat. No. 6,376,937 describe backup systems that also connect between a utility meter and its meter socket by way of a meter socket adapter.

One problem current energy supply systems with backup devices have is that once there is a power grid failure, the backup device has to supply power to all the electric appliances. In many instances, the system may fail temporarily or permanently due to insufficient backup power.

It is the object of the present invention to provide for a building energy supply having a reliable backup system, which is simple and cost effective to set up.

### SUMMARY OF THE INVENTION

In order to achieve the above-mentioned object, according to one aspect of the invention, an energy supply system is provided for supplying electrical energy to a building. The energy supply system comprises a meter socket adapter, which is constructed to be placed between a service panel socket and a standard utility power meter. For this purpose, the meter socket adapter may have the dimensions and jaw connections described in U.S. Pat. No. 7,648,389 B1 and U.S. Pat. No. 6,188,145 B1. In particular, the meter socket adapter has a meter side, which is engaged to a standard utility power meter, and a panel side, which is engaged to a service panel socket, whereby the service panel socket is originally constructed to engage with said utility power meter.

The meter side of the meter socket adapter comprises electrical grid side connections to receive power from the electrical grid and electrical load side connections to supply the received power to electrical appliances in said building. Depending on the number of phases leading to the utility power meter, there might be one, two or more grid side connections and a corresponding number of load side connections. For a low voltage system leading to a private building, often the neutral phase is not leading through the utility power meter, so that only two phases are provided at the service panel socket. In this case, there are two grid side connections and two load side connections provided in the meter socket adapter.

Without the meter socket adapter, i.e. when the utility power meter is directly placed on the service panel socket, the utility power meter provides an electric connection from the grid side connections to the load side connections. Only by removing the meter socket adapter, the electric connection would be opened. According to an important aspect of the invention, a principal switching device is provided between said grid side connections and said load side connections. Said principal switching device is constructed to, when activated, electrically disconnect one, two or more of said load side connections from the corresponding grid side connections, despite the utility meter being mounted on the meter adapter.

The energy supply system further comprises an electrical backup device. This might be an electric storage device such as a battery, an alternative energy source such as a wind turbine or a solar panel, or a conventional source of backup electrical power such as a backup power generator driven by a gasoline engine or a gas turbine. The backup device is constructed to supply electrical power to said electrical appliances in said building when said principal switching device is activated. However, in order to avoid an overload if the electrical power required by all appliances that are online surpasses the electrical power that the backup device can provide, at least one appliance disconnector is provided. The appliance disconnector is electrically placed between said backup device and one or more appliances of the building. It is constructed to, when activated, stop electrical power flow from said backup device to said appliance(s). This way, said appliance will not drain electrical energy from the backup device, which then has enough energy to support one or more further appliances that are more essential than the disconnected appliance(s).

In addition, a control device is connected to said principal switching device, said backup device, and said appliance disconnector. The control device is constructed to control said principal switching device and said appliance disconnector such that when said principal switching device is activated, electrical power flow from said backup device to said appliance is stopped, while at least a further appliance receives electrical power from said electrical backup device. With the help of the appliance disconnector, the control device may implement an emergency power prioritization in order to supply backup power only to appliances that are deemed essential, while disconnecting all other appliances from the backup system.

According to a further aspect of the invention, a method for supplying electrical energy to the building is provided. The control device may be designed to implement such a method, either in form of a hard wiring or in the form of software code carried out by a computer. Said method comprises the steps: activating a principal switching device, which is connected to grid side connections, for receiving power from the electrical grid, and load side connections, for supplying the received power to electrical appliances in said building, of an energy supply system for supplying electrical energy to said building, thereby electrically disconnecting one, two or more of said load side connections from the corresponding grid side connections; providing electrical power by an electrical backup device for said electrical appliances in said building; activating an appliance disconnector, which is electrically placed between said backup device and an appliance of said building, thereby stopping electrical power flow from said backup device to said appliance; and supplying at least a further appliance with electrical power from said electrical backup device.

According to yet a further aspect of the invention, a method for installing an energy supply system for supplying electrical energy to a building is provided. This method comprises the following steps: Inserting a meter socket adapter between a utility power meter and a service panel socket, wherein said meter socket adapter comprises grid side connections to receive power from the electrical grid, electrical load side connections to supply the received power to electrical appliances in said building, a principal switching device, which is constructed to, when activated, electrically disconnect one, two or more of said load side connections from the corresponding grid side connections, and a control device constructed to control said principal switching device; Setting up an electrical backup device for providing electrical power to said electrical appliances in said building; and Setting up said control device to control said principal switching device and an appliance or an appliance disconnector such that when said principal switching device is activated, electrical power flow from said backup device to said appliance is stopped, while at least a further appliance receives electrical power from said electrical backup device.

According to a further aspect of the invention, a meter socket adapter is provided. The meter socket adapter is constructed to be engaged on a meter side to a standard utility power meter and on a panel side to a service panel socket constructed to engage with said utility power meter. The meter side comprises electrical grid side connections to receive power from the electrical grid and electrical load side connections to supply the received power to electrical appliances in the building. The meter socket adapter furthermore comprises: a principal switching device connected to said grid side connections and said load side connections, wherein said principal switching device is constructed to, when activated, electrically disconnect one, two or more of said load side connections from the corresponding grid side connections; and a control device constructed to control said principal switching device and an appliance disconnector, which is electrically placed between an electrical backup device and an appliance of the building, such that when said principal switching device is activated, electrical power flow from said backup device to said appliance is stopped, while at least a further appliance receives electrical power from said backup device.

According to an advantageous embodiment, said meter socket adapter comprises on its meter side socket jaws arranged to receive jaw blades of said utility power meter and on its panel side jaw blades arranged to fit into socket jaws of said service panel socket. The socket jaws on the meter side are advantageously extended into the jaw blades on the panel side. Advantageously, there are four socket jaws arranged at corners of a rectangle or a square, and likewise for the jaw blades. Two of the socket jaws constitute said grid side connections, while the other two constitute said load side connections.

In order to provide a firm link between the meter adapter and the panel socket as well as between the meter and the meter adapter, in a preferred embodiment, said meter socket adapter comprises an enclosure having a meter side flange on its meter side and a panel side flange on its panel side for retainers to secure said body to said utility power meter and said service panel. The enclosure and the flanges may be made of a plastic or of a metallic material.

According to a compact embodiment, said principal switching device is placed inside said enclosure of the meter socket adapter. Alternatively, there might be leads connected to the grid side connections and the load side connections, which lead out of said enclosure and to a principal switching device located outside of the enclosure. In both cases, the principal switching device may be activated by the control device either via an electrical or mechanical connection, or remotely.

The appliance disconnector may be designed to disconnect an individual appliance such as an air conditioning system or a refrigerator, or it may be designed to disconnect multiple appliances at once, for example appliances located in a certain room or section of the building. Advantageously, said appliance disconnector is placed inside said service panel or inside a distribution board of said building. The appliance disconnector may for example be a switchable fuse located inside the service panel of said building. In order to set up the energy supply system, one may thus have to replace an already existing fuse inside the service panel or inside the distribution board with the switchable fuse, which then acts as an appliance disconnector.

Said appliance disconnector may alternatively be placed at or inside said appliance, which it is supposed to disconnect. For example, the appliance disconnector may be a device put between the power cord of the appliance and a wall socket.

In a preferred embodiment, said appliance disconnector is controlled remotely by said control device. This may be achieved via a radio signal or via a wireless local area network connection. This has the advantage of simplifying the installation costs and efforts significantly. The appliance disconnector may be part of a building automation system, which controls a number of appliances or all appliances in the building. In this case, the control device may be synchronized with the building automation system when setting up the system. In case of automated or intelligent appliances, the appliance disconnector may be part of the control system of the appliance. In this case, the control device will send a signal to the control system of the appliance when attempting to activate the disconnector.

According to an advantageous embodiment, said control device is constructed to activate said appliance disconnector in dependence of a state of charge (SOC) or a power level of said backup device. If the backup device comprises a battery, it is important to incorporate the state of charge of the battery in the emergency power prioritization, i.e. in the decision, which appliances are supposed to be served by the backup device. If the state of charge is high enough, the system might still work reliably, even if most or all the appliances are served. The same applies for the power level of the backup device, if it comprises a conventional or alternative energy source such as a solar panel. If, in the case of a solar panel, there is not enough sunlight, the power produced by the backup device might not be sufficient to support many appliances, in which case only the very essential appliances are to be served.

According to a preferred embodiment, a grid power monitoring device is provided for monitoring the voltage or power level at said grid side connections. Once the power level at said grid side connections falls below a certain limit to be regarded as a power failure, the grid power monitoring device should alert the control device, e.g. by sending an emergency signal. Said control device is then able to control said principal switching device in dependence of the result of the monitoring of said power level.

According to a further aspect of the invention, the control device is constructed to, depending on the voltage level of said electrical grid or depending on a power level of the backup device, either activate the principal switching device and allow only the backup device to supply the grid side connections with electrical power or to maintain a connection of said backup device with said electrical grid. In addition, the control devise may take into account the load demand of the building, i.e. the energy demands of the appliances of the building or the energy demands of just the necessary appliances.

In other words, the control device monitors the grid power level, the backup device power level and/or the load power demand and decides, based on one, two or all three of these parameters, whether to activate said principal switching device. The decision algorithm may e.g. involve a threshold control to activate said principal switching device once the grid power level falls below a certain threshold. Once the principal switching device is activated, the backup device may be activated to supply appliances with power. In some cases, it might be advantageous to have the backup device connected and activated even when the appliances are supplied through the power grid, i.e. even in an on-line mode. The backup device may then be either in a charging mode, behaving like a load, or it may be complementing the power grid by providing a portion of the power demanded by the appliances.

Advantageously, in the case when a number of different backup devices are provided, the control device is designed to ensure that only one of the backup devices is connected to any appliance. For example, in one case, one appliance may be served by a battery, while a different appliance may be served by a solar panel. In another case, one or more first appliances may be connected to a first battery and one or more second appliances may be connected to a second battery.

In order for the backup device to be able to feed power to an appliance, a connection line has to be established between the backup device and the appliance. This can be done in a variety of ways. According to one preferred embodiment, said further appliance is supplied with electrical power from said electrical backup device through said load side connections through the meter socket adapter described above. For this purpose, the meter socket adapter would comprise connection means for connecting said electrical backup device to supply the grid side connections with electrical power when said principal switching device is activated. The connection leads connecting the backup device with the load side connections may in this case be fed through a hole in the side of the meter adapter enclosure.

The connection leads may alternatively be fed through a gap between the meter socket adapter and the utility power meter or the service panel meter. In other embodiments, the backup device is connected to the appliance through connection leads running through the service panel, through a sub-panel or through a gap between the service panel and a sub-panel. In yet further embodiments, the connection leads are bundled with electrical wires coming from or going to the service panel or a sub-panel.

### BRIEF DESCRIPTION OF THE DRAWINGS

The present invention will be explained in more detail in the following text with reference to preferred embodiments of an energy supply system according to the invention, which are illustrated in FIG. 1 through FIG. 4 and are not intended to be restrictive.

FIG. 1 is a schematic diagram of an energy supply system comprising a service panel having a socket, a utility power meter and a meter socket adapter;

FIG. 2a is a schematic diagram of a view onto a meter side of a meter socket adapter;

FIG. 2b is a schematic diagram of a view onto a panel side of a meter socket adapter; and

FIG. 3 is a schematic wiring diagram of an energy supply system in accordance with a preferred embodiment.

### DETAILED DESCRIPTION

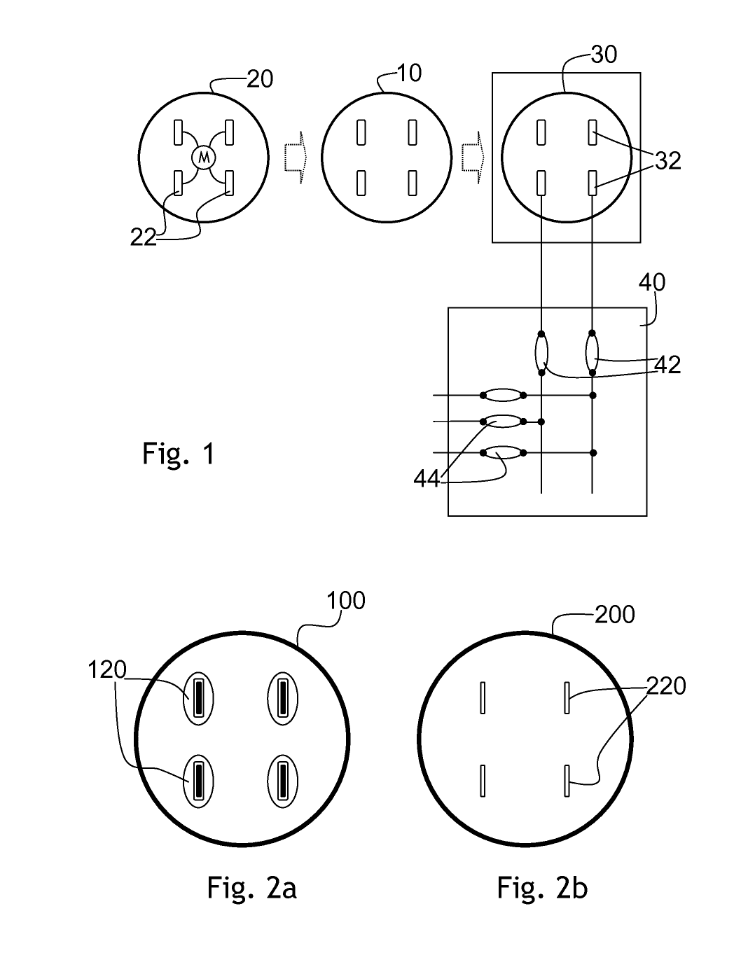

FIG. 1 shows the energy supply system according to a preferred embodiment. In a general distribution panel set-up, a service panel socket 30 is constructed to receive a standard utility power meter 20. The power meter 20 has power meter jaw blades 22 that fit into panel socket jaws 32 of the service panel socket 30 in order to engage the power meter 20 with the service panel socket 30. The service panel socket 30 is connected to a distribution panel or service panel 40 of a building. It houses main fuses 42 and appliance fuses 44, which can be serviced when needed. Each of the appliance fuses 44 corresponds to an individual appliance (not shown) or to a set of appliances, e.g. in a section of the building.

According to the embodiment shown here, the power meter 20 is removed from the service panel socket 30 and replaced by a meter socket adapter 10. The power meter 20 itself is then placed onto the meter socket adapter 10 in order to continue to fulfil its function. The meter socket adapter 10 has a cylindrical shape and comprises two sides facing away from each other, which are shown in FIGS. 2a and 2b. A meter side 100 of the adapter 10 is designed to be engageable to the power meter 20. For this purpose, socket jaws 120 are provided on the meter side 100, which are similar in shape and position to the panel socket jaws 32 of the panel socket 30 and in which the power meter jaw blades 22 can be inserted. Facing away from the meter side 100, a panel side 200 of the adapter 10 is designed to be engageable to the service panel socket 30. For this purpose, jaw blades 220 are provided on the panel side 200, which are similar in shape and position to the meter jaw blades 22 of the power meter 20 and which can be inserted into the panel socket jaws 32. Both the meter side 100 and the panel side 200 may have retainers to secure the body of the adapter 10 to the utility power meter 20 and the service panel 30.

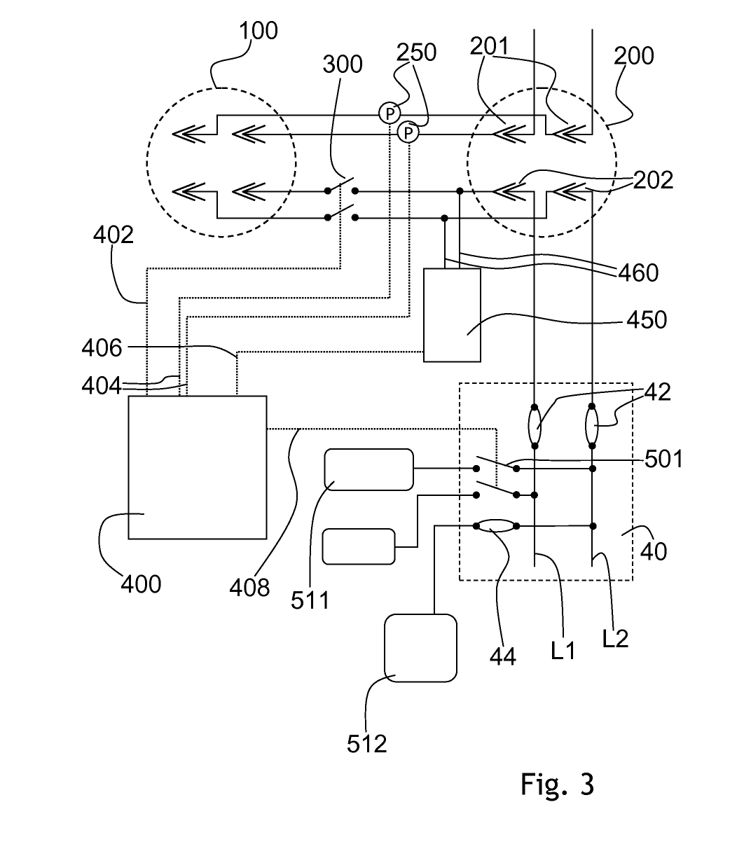

A schematic wiring diagram of an energy supply system in accordance with a preferred embodiment is shown in FIG. 3. Therein, the meter side 100 and the panel side 200 of the meter adapter 10 are each indicated as a dashed circle.

Inside the dashed circles, arrowheads represent the connection means such as socket jaws and jaw blades described above. The system shown in FIG. 3 may be a multi-phase system, wherein the neutral phase has not been fed through the panel socket.

The panel side 200 contains two grid side connections 201, each for one phase of the power grid line leading to the building's service panel. Furthermore, two load side connections 202 are provided, each of which are connected through a main fuse 42 and an appliance fuse 44 to one or more appliances 511, 512 inside or about the building. One of the load side connections 202 is connected to the leg-1 conductor L1 inside the service panel 40, while the other of the load side connections 202 is connected to the leg-2 conductor L2.

The solid lines leading from the panel side 200 to the meter side 100 represent the inner structure of the meter socket adapter. Instead of directly connecting the connections on the panel side 200 to the connections on the meter side 100, there is a principal switching device 300 placed between the load side connections 202 and the corresponding connections on the meter side. The principal switching device 300 may be located either inside an enclosure of the adapter, or it may be connected via leads such as wires leading out of that enclosure.

The principal switching device 300 is connected to a control device 400 by way of a switch control signal 402. The signal lines in FIG. 3 are represented by dotted lines. They may be realized as physical wires for transmitting and receiving the corresponding signal electrically. Alternatively, any or all of the signal lines may be implemented for wireless transmission, e.g. via radio signals, via infrared signals or the like. A backup device 450 is shown connected to the load side connections 202 of the adapter via connection leads 460. Once the principal switching device 300 is activated, the connection between the grid side connections 201 and the load side connections 202 is interrupted and the load, namely the appliances 511, 512 do not receive their power from the power grid any longer. Instead, they may be served by power from the backup device 450.

Instead of connecting to the load side connections 202, the backup device 450 may be connected to any other part of the system, as long as it is ensured that the appliances 511, 512 can obtain power from the backup device 450 once the principal switching device 300 is activated. In an extreme case, the backup device 450 may be connected directly to an appliance 511, while a further backup device (not shown) is connected to a further appliance 512.

The backup device 450 is connected to the control device 400 via a backup control signal 406, which serves for data communication from and to the backup device 450. For example, the backup device 450 may transmit information about its power level or, in case it comprises a battery, its state of charge to the control device 400. Furthermore, two power monitors 250 are connected to the grid side connections 201 in order to monitor the power level or voltage level provided by the power grid. The monitored parameters are fed to the control device 400 via power monitor signals 404.

As can be seen when comparing FIG. 1 and FIG. 3, some appliance fuses 44 are replaced by appliance disconnectors 501, which are controllable by the control device 400 via a disconnector signal 408. Herein, the appliance 511 is connected to the L2 conductor through the appliance disconnector 501 and can thus be disconnected from the power supplied via the load side connections 202, when the control device 400 sends an appropriate signal to the appliance disconnector 501. In contrast, the further appliance 512 is still connected to the L1 conductor through a regular fuse 44 and can thus not be disconnected by the control device 400. Thus, the further appliance 512 can be seen as an essential appliance, which is to be supplied with power by the backup device 450 in any case. Alternatively, even when the further appliance 512 is essential, the fuse 44 leading to the further appliance 512 may also be replaced by an appliance disconnector 511, but with the control device 400 programmed appropriately to avoid activating it.

According to one preferred embodiment, a method for supplying electrical energy to the building may follow the following course. When the grid voltage at the grid side connections 201 drops below a certain voltage level, this change is picked up by the power monitors 250, alerting the control device 400. The control device 400 then activates the principal switching device 300, disconnecting the load side connections 202 from the grid side connections 201. Then, the backup device 450 is activated by the control device 400 if necessary, i.e. if it has not been already active all along. Now the voltage at the load side connections 202 is supplied by the backup device 450. Activating the principal switching device 300 ensures that the voltage supplied by the backup device 450 is not applied to the grid side connections 201, which might cause interference with the power grid.

If the backup device 450 can supply enough power, it may replace the power grid in supplying all appliances 512, 512 with power until the principal switching device 300 is deactivated again. In this case, the control device 400 will leave the appliance disconnectors 501 deactivated. However, if the control device 400 determines that an emergency power prioritization has to be implemented, it may send disconnector signals 408 to the appliance disconnectors 501 in order to activate them. In this case, only the further appliance 512 stays connected to the corresponding conductor L2 of the service panel.

Once the power level at the grid side connections 201 is back to normal, this is registered again by the power monitors 250, which alert the control device 400 via the power monitor signal 404. The control device 400 can then deactivate both the appliance disconnectors 501 and the principal switching device 300. The backup device 450 may continue to be active and connected to the system, either for the purpose of charging a battery, which may be part of the backup device 450, or for the purpose of supplying auxiliary power to the appliances 511, 512. In the latter case, the appliances 511, 512 will draw less power from the grid.

### REFERENCE NUMERALS

10 meter socket adapter
20 utility power meter
22 power meter jaw blades
30 service panel socket
32 panel socket jaws
40 service panel or distribution panel
42 main fuses
44 appliance fuses
100 meter side of meter socket adapter
120 socket jaws
200 panel side of meter socket adapter
220 jaw blades
201 grid side connections
202 load side connections
250 power monitor
300 principal switching device
400 control device
402 switch control signal
404 power monitor signal
406 backup control signal
408 disconnector signal
450 backup device
460 backup device connection leads
501 appliance disconnector
511 appliance
512 further appliance

1. An energy supply system for supplying electrical energy to a building, comprising:
a meter socket adapter constructed to be engaged on a meter side to a standard utility power meter and on a panel side to a service panel socket constructed to engage with said utility power meter, wherein the meter side comprises electrical grid side connections to receive power from the electrical grid and electrical load side connections to supply the received power to electrical appliances in said building;
a principal switching device connected to said grid side connections and said load side connections, wherein said principal switching device is constructed to, when activated, electrically disconnect one, two or more of said load side connections from the corresponding grid side connections;
an electrical backup device constructed to supply electrical power to said electrical appliances in said building when said principal switching device is activated;
an appliance disconnector electrically placed between said backup device and an appliance of the building and constructed to, when activated, stop electrical power flow from said backup device to said appliance; and
a control device constructed to control said principal switching device and said appliance disconnector such that when said principal switching device is activated, electrical power flow from said backup device to said appliance is stopped, while at least a further appliance receives electrical power from said electrical backup device.

2. The energy supply system according to claim 1, wherein said meter socket adapter comprises on its meter side socket jaws arranged to receive jaw blades of said utility power meter and on its panel side jaws arranged to fit into socket jaws of said service panel socket.

3. The energy supply system according to claim 1, wherein said meter socket adapter comprises an enclosure having a meter side flange on its meter side and a panel side flange on its panel side for retainers to secure said body to said utility power meter and said service panel.

4. The energy supply system according to claim 3, wherein said principal switching device is placed inside said enclosure of the meter socket adapter.

5. The energy supply system according to claim 1, wherein said appliance disconnector is placed inside said service panel or inside a distribution board of said building.

6. The energy supply system according to claim 1, wherein said appliance disconnector is placed at or inside said appliance.

7. The energy supply system according to claim 1, wherein said appliance disconnector is controlled remotely by said control device.

8. The energy supply system according to claim 1, wherein said control device is constructed to activate said appliance disconnector in dependence of a state of charge or a power level of said backup device.

9. The energy supply system according to claim 1, further comprising a grid power monitoring device for monitoring the voltage level at said grid side connections.

10. The energy supply system according to claim 9, whereby said control device is constructed to control said principal switching device in dependence of the result of the monitoring of said voltage level.

11. The energy supply system according to claim 10, wherein said control device is constructed to, depending on the voltage level of said electrical grid or depending on a power level of the backup device, either activate the principal switching device and allow only the backup device to supply the grid side connections with electrical power or to maintain a connection of said backup device with said electrical grid.

12. A method for supplying electrical energy to a building, comprising the following steps:
activating a principal switching device, which is connected to grid side connections, for receiving power from the electrical grid, and load side connections, for supplying the received power to electrical appliances in said building, of an energy supply system for supplying electrical energy to said building, thereby electrically disconnecting one, two or more of said load side connections from the corresponding grid side connections;
providing electrical power by an electrical backup device for said electrical appliances in said building;
activating an appliance disconnector, which is electrically placed between said backup device and an appliance of said building, thereby stopping electrical power flow from said backup device to said appliance; and
supplying at least a further appliance with electrical power from said electrical backup device.

13. The method according to claim 12, wherein activating said principal switching device electrically disconnects one, two or more of said load side connections, which are located inside a meter socket adapter, from the corresponding grid side connections, which are located inside said meter socket adapter, wherein said meter socket adapter is engaged on a meter side to a standard utility power meter and on a panel side to a service panel socket, which is constructed to engage with said utility power meter.

14. The method according to claim 12, wherein said further appliance is supplied with electrical power from said electrical backup device through said load side connections through a meter socket adapter engaged on a meter side to a standard utility power meter and on a panel side to a service panel socket constructed to engage with said utility power meter.

15. A method for installing an energy supply system for supplying electrical energy to a building, comprising the following steps:
Inserting a meter socket adapter between a utility power meter and a service panel socket, wherein said meter socket adapter comprises grid side connections to receive power from the electrical grid, electrical load side connections to supply the received power to electrical appliances in said building, a principal switching device, which is constructed to, when activated, electrically disconnect one, two or more of said load side connections from the corresponding grid side connections, and a control device constructed to control said principal switching device;
Setting up an electrical backup device for providing electrical power to said electrical appliances in said building; and
Setting up said control device to control said principal switching device and an appliance or an appliance disconnector such that when said principal switching device is activated, electrical power flow from said backup device to said appliance is stopped, while at least a further appliance receives electrical power from said electrical backup device.

16. The method according to claim 16, wherein setting up said control device to control said appliance or said appliance disconnector comprises replacing a fuse inside a distribution board of said building with said appliance disconnector.

17. A meter socket adapter constructed to be engaged on a meter side to a standard utility power meter and on a panel side to a service panel socket constructed to engage with said utility power meter, wherein the meter side comprises electrical grid side connections to receive power from the electrical grid and electrical load side connections to supply the received power to electrical appliances in the building, whereby the meter socket adapter comprises:
a principal switching device connected to said grid side connections and said load side connections, wherein said principal switching device is constructed to, when activated, electrically disconnect one, two or more of said load side connections from the corresponding grid side connections; and
a control device constructed to control said principal switching device and an appliance disconnector, which is electrically placed between an electrical backup device and an appliance of the building, such that when said principal switching device is activated, electrical power flow from said backup device to said appliance is stopped, while at least a further appliance receives electrical power from the said backup device.

18. The meter socket adapter according to claim 17, comprising on its meter side socket jaws arranged to receive jaw blades of said utility power meter and on its panel side jaw blades arranged to fit into socket jaws of said service panel socket.

19. The meter socket adapter according to claim 17, further comprising an enclosure having a meter side flange on its meter side and a panel side flange on its panel side for retainers to secure said body to said utility power meter and said service panel.

20. The meter socket adapter according to claim 17, further comprising connection means for connecting said electrical backup device to supply the grid side connections with electrical power when said principal switching device is activated.
